(19) United States
(12) Patent Application Publication
(10) Pub. No.: US 2010/0262634 A1
(43) Pub. Date: Oct. 14, 2010

(54) FILE MANAGING SYSTEM AND METHOD

(75) Inventor: Cho-Hao Wang, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-cheng (TW)

(21) Appl. No.: 12/510,280

(22) Filed: Jul. 28, 2009

(30) Foreign Application Priority Data
Apr. 14, 2009 (CN) 200910301513.5

(51) Int. Cl. G06F 17/30; G06F 17/00

(52) U.S. Cl. 707/812; 706/59; 707/E17.01

(57) ABSTRACT

A file managing system manages files in a mobile device when the files are uploaded into a computer system. The file managing system builds a storing rule, creates new folders in the computer system according to the storing rule, and names the new folders according to information of the files. The file managing system further copies the files in the mobile device into the new folders in the computer system according to the information of the files in the mobile device.

### BACKGROUND

1. Technical Field

The present disclosure relates to a file managing system and a file managing method.

2. Description of Related Art

Nowadays, with the development of science and technology, more and more mobile devices are coming into use. When files in the mobile devices are uploaded into the computer system, users often need to classify the files into different categories for searching easily later. As a result, it is inconvenient for users to classify the files manually, especially, when there are large numbers of files.

### BRIEF DESCRIPTION OF THE DRAWINGS

FIG. 1 is a schematic diagram of an exemplary embodiment of a file managing system, the file managing system includes a storage system.

FIG. 2 is a schematic diagram of the storage system of FIG. 1, according to an embodiment.

FIG. 3 is a flowchart of an exemplary embodiment of a file managing method used for the file managing system of FIG. 1.

FIGS. 4A-4E are schematic diagrams of copying files from a mobile device to a computer system using the file managing system of FIG. 1.

### DETAILED DESCRIPTION

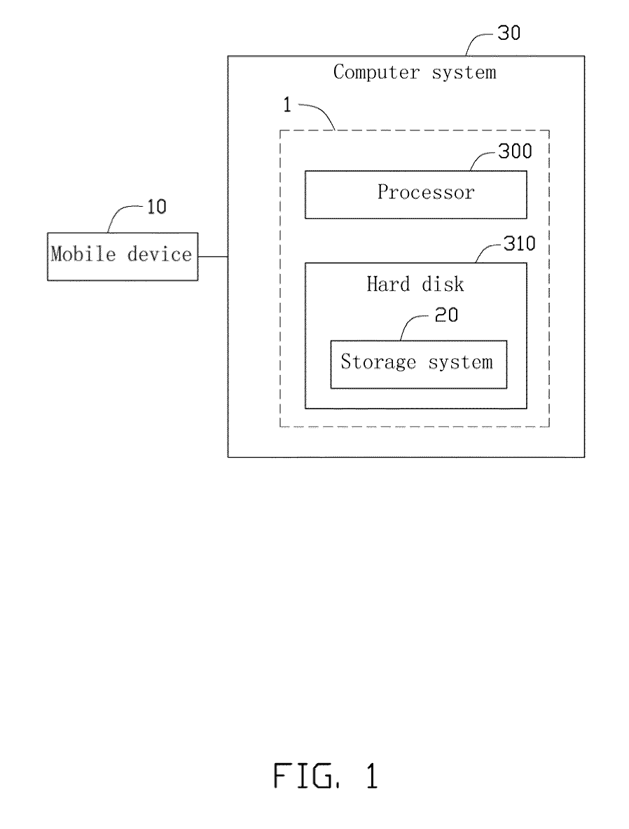

Referring to FIG. 1, an exemplary embodiment of a file managing system 1 includes a storage system 20 and a processor 300. The file managing system 1 is operable to copy files stored in a mobile device 10 to a computer system 30, and classify the files into different categories. As a result, the files copied to the computer system 30 can be searched easily. It can be understood that the storage system 20 and the processor 300 may belong to the computer system 30.

The computer system 30 is generally controlled and coordinated by an operating system, such as the UNIX, Linux, Windows 95, 98, NT, 2000, XP, Vista, Mac OS X, an embedded operating system, or any other compatible operating system. In other embodiments, the computer system 30 may be controlled by a proprietary operating system. Conventional operating systems control and schedule computer processes for execution, perform memory management, provide file system, networking, and I/O services, and provide a user interface, such as a graphical user interface (GUI), among other things.

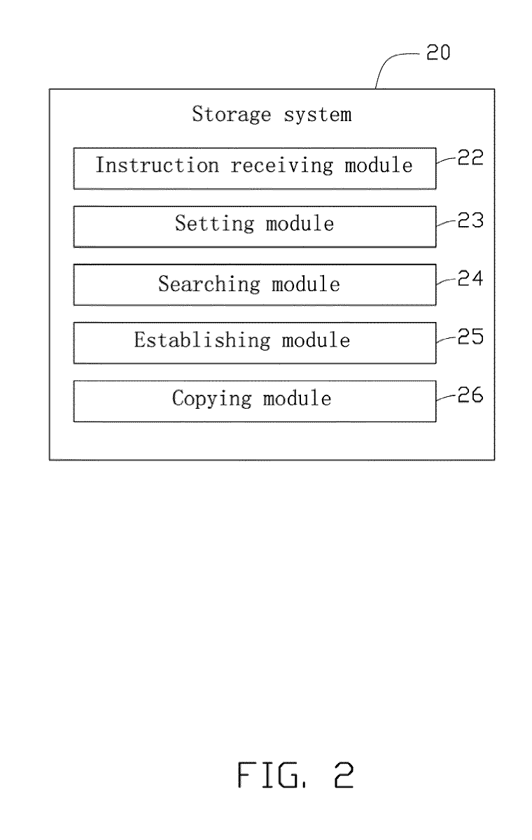

Referring to FIG. 2, the storage system 20 includes an instruction receiving module 22, a setting module 23, a searching module 24, an establishing module 25, and a copying module 26. The instruction receiving module 22, the setting module 23, the searching module 24, the establishing module 25, and the copying module 26 may include one or more computerized instructions and are executed by the processor 300 in the computer system 30. It can be understood that the storage system 20 may be stored in a hard disk 310 of the computer system 30.

In general, the word “module,” as used herein, refers to logic stored in hardware, or to a collection of software instructions, written in a programming languages, such as, Java, C, or assembly. One or more software instructions in the modules may be stored in hardware, such as the hard disk. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

The instruction receiving module 22 receives an instruction, to activate the setting module 23, the searching module 24, the establishing module 25, and the copying module 26, or not to activate these modules according to the instruction. The meaning of activating a module is that the module is caused to function, and the meaning of not activating a module is that the module is not caused to function. In the embodiment, the instruction may include a copying instruction and an examining instruction. Upon the condition that the instruction receiving module 22 receives the copying instruction, the instruction receiving module 22 activates the setting module 23, the searching module 24, the establishing module 25, and the copying module 26. Upon the condition that the instruction receiving module 22 receives the examining instruction, the instruction receiving module 22 does not activate the setting module 23, the searching module 24, the establishing module 25, and the copying module 26.

The setting module 23 builds a storing rule according to users' habit. It can be understood that the users' habit is how the users normally classify the files. For example, the users classify music files into different categories according to publish time and singer. As a result, the storing rule the setting module 23 builds may include a first level folder named Music, a second level folder named with singers' names, such as “Linkin Park”, and a third level folder named by year “2008.” In other embodiments, the storing rule can be modified according to need. For example, users can modify the second level folder with year “2008,” and the third level folder named “Linkin Park.”

The searching module 24 obtains information of the files in the mobile device 10 according to the storing rule. In the embodiment, the information of the files may include format of the files and summaries of the files. It can be understood that the format of the files denotes that the files are video files, music files, or other files. The searching module 24 can obtain the format of the files according to name extensions of the files. For example, a file with a name extension of “.avi” is a video file, and another file with a name extension of “.mp3” is a music file. The summaries of the files may include authors and remarks of the files.

The establishing module 25 creates new folders in the computer system 30 according to the storing rule, and names the new folders according to the information of the files in the mobile device 10. For example, the establishing module 25 creates first level new folders and names the new folders as Music and Video.

The copying module 26 copies the files in the mobile device 10 into the new folders in the computer system 30 according to the information of the files. For example, the copying module 26 copies the files with a name extension of “.avi” into the folders named Video, and copies the files with a name extension of “.mp3” into the folders named Music.

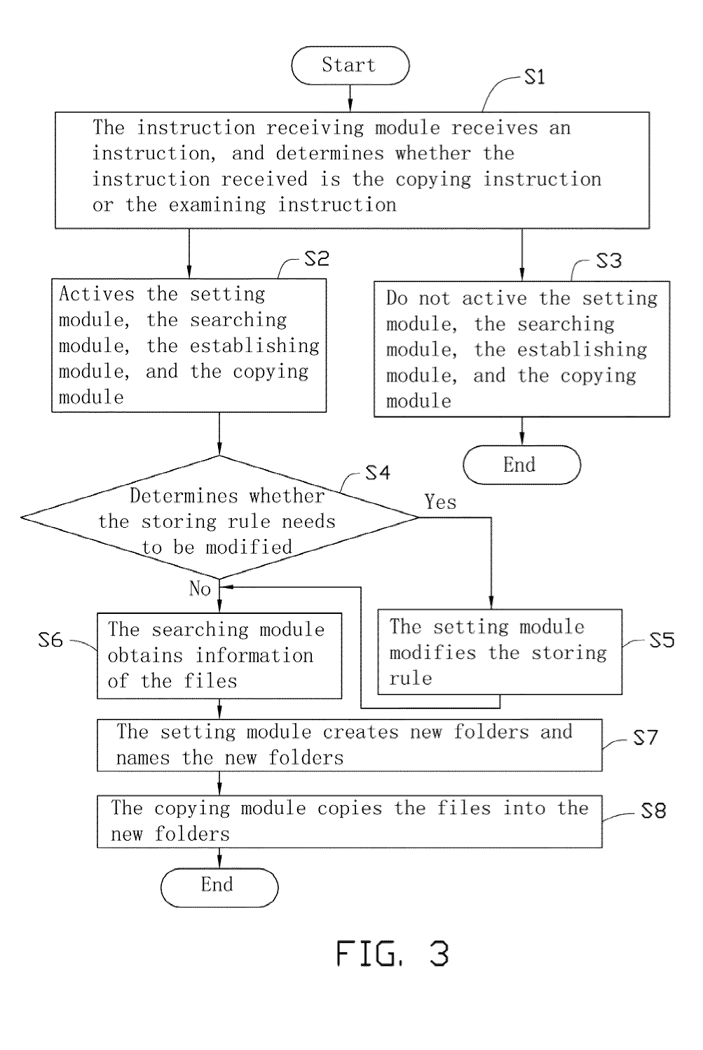

Referring to FIG. 3, an exemplary embodiment of a file managing method is operable to copy files in the mobile device 10 to the computer system 30. The file managing method includes the following steps.

In step S1, the instruction receiving module 22 receives an instruction. In the embodiment, the instruction may include the copying instruction and the examining instruction. The instruction receiving module 22 determines whether the instruction received is the copying instruction or the examining instruction. Upon the condition that the instruction received is the copying instruction, the flow goes to step S2. Upon the condition that the instruction received is the examining instruction, the flow goes to step S3.

In step S2, the instruction receiving module 22 activates the setting module 23, the searching module 24, the establishing module 25, and the copying module 26. The flow goes to step S4.

In step S3, the instruction receiving module 22 does not activate the setting module 23, the searching module 24, the establishing module 25, and the copying module 26. It can be understood that users do not need to copy files in the mobile device 10 into the computer system 30. As a result, the flow ends.

In step S4, the setting module 23 builds the storing rule according to users' habit. For example, the storing rule that the setting module 23 builds may include a first level folder named Music, a second level folder named singers' names, such as “Linkin Park,” and a third level folder named 2008. The setting module 23 further determines whether the storing rule needs to be modified. Upon the condition that the storing rule needs to be modified, the flow goes to step S5. Upon the condition that the storing rule needs not to be modified, the flow goes to step S6.

In step S5, the setting module 23 modifies the storing rule according to need. For example, the storing rule includes the first level folder named Music, the second level folder named 2008, and the third level folder named singers' name, such as “Linkin Park.” The flow goes to step S6.

In step S6, the searching module 24 obtains information of the files in the mobile device 10 according to the storing rule. It can be understood that the information of the files may include format of the files and summaries of the files.

In step S7, the setting module 25 creates new folders in the computer system 30 according to the storing rule, and names the new folders according to the information of the files in the mobile device 10. For example, the setting module 25 creates a first new folder and a second new folder, and names the first new folder as Music and names the second new folder as 2008.

In step S8, the copying module 26 copies the files in the mobile device 10 into the new folders in the computer system 30 according to the information of the files. For example, the copying module 26 copies the files with a name extension of “.avi” into the folders named Video, and copies the files with a name extension of “.mp3” into the folders named Music.

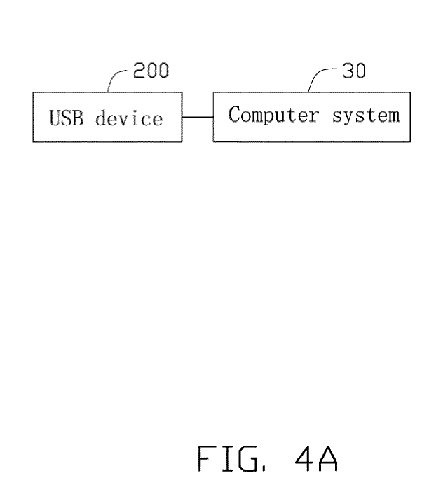

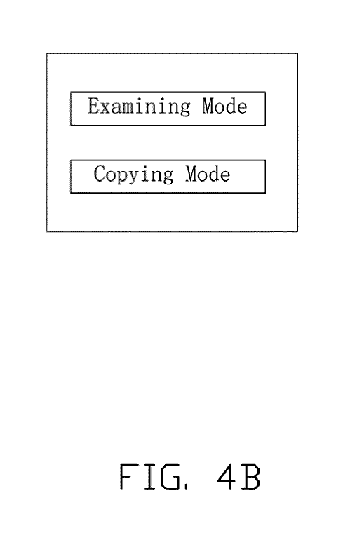

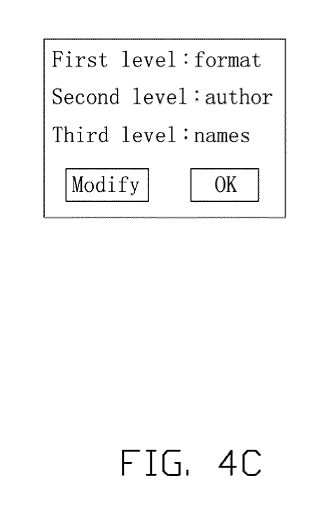

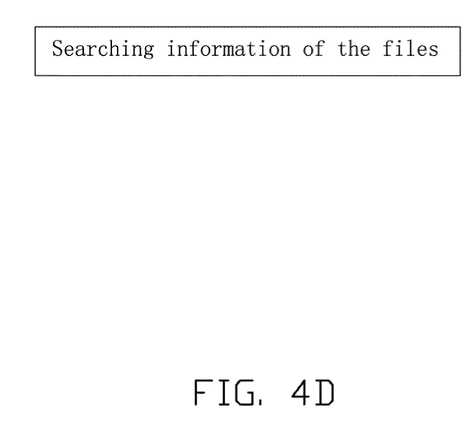

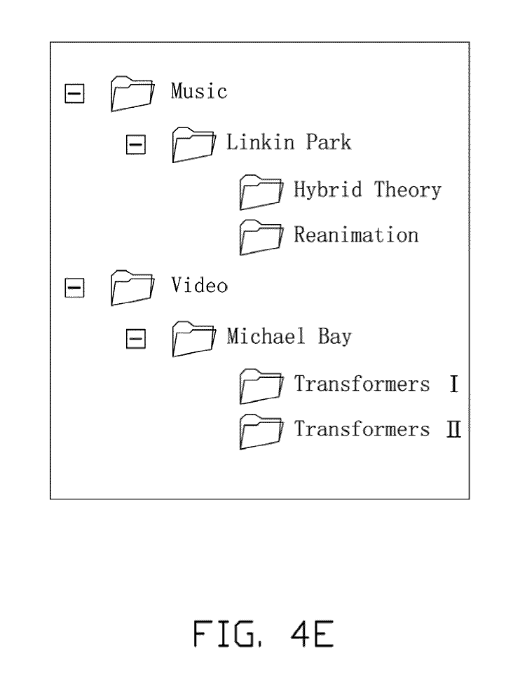

Referring to FIGS. 4A-4E, the mobile device 10 is connected, via a Universal Serial Bus (USB) device 200, to the computer system 30 through a USB cable (not shown).

The USB device 200 stores a plurality of music files and video files. When the file managing system 1 is at work, a monitor of the computer system 30 displays a first dialog box shown in FIG. 4B. In the FIG. 4B, the first dialog box includes an Examining Mode button and a Copying Mode button.

Upon the condition that the Examining Mode button is pressed, the file managing system 1 stops working. The monitor displays the files in the USB device 200. Upon the condition that the Copying Mode button is pressed, the monitor displays a second dialog box shown in FIG. 4C. In FIG. 4C, the monitor displays the storing rule, a Modify button, and an OK button. The storing rule includes a first level, a second level, and a third level. In the embodiment, the first level is format of the files, such as music and video. The second level is authors of the files, such as Linkin Park and Michael Bay. The third level is names of the files, such as Hybrid Theory, Reanimation, Transformers I and Transformers II.

Upon the condition that the storing rule needs to be modified, the Modify button is pressed. As a result, a modify dialog box is displayed on the monitor. Users can modify the storing rule according to need. The Ok button is pressed to save the storing rule.

After the modification is accomplished, the monitor displays a third dialog box shown in FIG. 4D. It can be understood that the file managing system 1 is searching information of the files in the USB device 200 according to the storing rule.

After the search is accomplished, the file managing system 1 creates a plurality of new folders in the computer system 30, as shown in FIG. 4E. For example, the new folders may include two first level folders, two second level folders, and four third level folders. The two first level folders include a first folder named Music and a second folder named Video. The two second level folders include a third folder named Linkin Park belonged to the first folder, and a fourth folder named Michael Bay belonged to the second folder. The four third level folders include a fifth folder named Hybrid Theory belonged to the third folder, a sixth folder named Reanimation belonged to the third folder, a seventh folder named Transformers I belonged to the fourth folder, and an eighth folder named Transformers II belonged to the fourth folder.

The copying module 26 copies the files in the USB device 200 into the computer system 30 correspondingly. As a result, the files can be found easily in the computer system 30.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A file managing system comprising:
a processor;
a storage system connected to the processor and storing one or more computerized instructions to be executed by the processor, wherein the storage system comprises:
a setting module to build a storing rule;
a searching module to obtain information of files in a mobile device according to the storing rule;
an establishing module to create new folders in a computer system according to the storing rule, and names the new folders according to the information of the files in the mobile device; and
a copying module to copy the files in the mobile device into the new folders in the computer system according to the information of the files in the mobile device.

2. The file managing system of claim 1, further comprising an instruction receiving module to receive an instruction, to determine whether to activate the setting module, the searching module, the establishing module, and the copying module.

3. The file managing system of claim 2, wherein the instruction is an examining instruction or a copying instruction, upon the condition that the instruction is the examining instruction, the instruction receiving module does not activate the setting module, the searching module, the establishing module, and the copying module; upon the condition that the instruction is the copying instruction, the instruction receiving module activates the setting module, the searching module, the establishing module, and the copying module.

4. The file managing system of claim 1, wherein the setting module is further operable to modify the storing rule.

5. A computer-implemented method for managing files of a mobile device, the method comprising:
building a storing rule;
obtaining information of the files in the mobile device according to the storing rule;
creating new folders in a computer system according to the storing rule, and naming the new folders according to the information of the files in the mobile device; and
copying the files in the mobile device to the new folders in the computer system according to the information of the files.

6. The method of claim 5, wherein before the step of building a storing rule, the method further comprises:
receiving an instruction;
determining whether the instruction is an examining instruction or a copying instruction;
upon the condition that the instruction is the examining instruction, the method ends; and
upon the condition that the instruction is the copying instruction, the method goes to the step of building a storing rule.

7. The method of claim 5, wherein between the step of building a storing rule and the step of obtaining information, the method further comprises:
determining whether the storing rule need to be modified; and
modifying the storing rule in response to the storing rule needing to be modified.

8. A storage medium having stored thereon instructions that, when executed by a processor, causing the processor to perform a method for managing files in a mobile device, wherein the method comprises:
building a storing rule;
obtaining information of the files in the mobile device according to the storing rule;
creating new folders in a computer system according to the storing rule, and naming the new folders according to the information of the files in the mobile device; and
copying the files in the mobile device to the new folders in the computer system according to the information of the files.

9. The storage medium of claim 8, wherein before the step of building a storing rule, the method further comprises:
receiving an instruction;
determining whether the instruction is an examining instruction or a copying instruction;
upon the condition that the instruction is the examining instruction, the method ends; and
upon the condition that the instruction is the copying instruction, the method goes to the step of building a storing rule.

10. The storage medium of claim 8, wherein between the step of building a storing rule and the step of obtaining information, the method further comprises:
determining whether the storing rule need to be modified; and
modifying the storing rule in response to the storing rule need to be modified.
